(19) United States
(12) Patent Application Publication
(10) Pub. No.: US 2006/0270466 A1
(43) Pub. Date: Nov. 30, 2006

(54) Method for connecting handset to bluetooth hands-free unit

(75) Inventor: Ren-Shiou Liu, Hualien County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/441,249

(22) Filed: May 26, 2006

(30) Foreign Application Priority Data
May 31, 2005 (TW) 094117765

(51) Int. Cl. H04M 1/00

(52) U.S. Cl. 455/569.1; 455/41.2

(57) ABSTRACT

A method for connecting a handset to a Bluetooth hands-free unit, comprising: determining a service port of the Bluetooth hands-free unit in a data base of the handset; establishing an initial connection between the handset and the Bluetooth hands-free unit according to the service port; performing an incoming call setup procedure in order for the Bluetooth hands-free unit to receive an incoming call; and performing a service level connection establishment procedure.

### BACKGROUND OF THE INVENTION

1. Field of the Invention

The present invention generally relates to a method for connecting a handset to a Bluetooth hands-free unit and, more particularly, to a method for automatically connecting a handset to a Bluetooth hands-free unit when the handset is to make or receive a phone call while being disconnected from the Bluetooth hands-free unit.

2. Description of the Prior Art

In recent years, with the development and popularity in Bluetooth wireless technology, Bluetooth compatibility has gradually become required for modern handsets. More and more vehicles are also equipped with a Bluetooth hands-free unit such that users, while they are driving, can not only receive incoming calls through a microphones and a speaker but also make outgoing calls through voice control or a Bluetooth hands-free unit. Wireless communication is indeed convenient but still not as reliable as a wired link when it comes to vehicle uses. For example, the link between a handset and a Bluetooth hands-free unit maybe interrupted due to unexpected reasons that lead to un-received incoming calls.

In U.S. Pat. No. 6,687,517, it is disclosed a technique for allowing hands-free operation of a mobile telephone in a vehicle utilizing a low-power wireless communication link, such as the Bluetooth System, to connect the mobile telephone to the hands-free device disposed within the vehicle.

FIG. 1 is a flowchart illustrating an example of the steps of the technique in the prior art. When a car turns the ignition on in Step S100, a hands-free unit within Bluetooth module in car starts paging a default mobile unit within Bluetooth module as noted in Step S110. If the default mobile unit is found as noted in Step S120, the hands-free unit automatically connects to the default mobile unit, as stated in Step S170, to enable the default mobile unit to make or receive telephone calls using the hands-free unit without removing his or her mobile telephone from his briefcase or handbag or pocket. On the other hand, in the absence of a response to the default mobile unit page of Step S110, a last mobile unit is paged in Step S130. The last mobile unit is a mobile unit which is operated with the hands-free device last time. The last mobile unit will be automatically connected to the hands-free device when there is no default mobile unit in the vehicle. If the last mobile unit is found in Step S140, then the last mobile unit is connected to the hands-free device via the Bluetooth System link as noted in Step S180. In the absence of last mobile unit being found in Step S140, the hands-free device remains in a standby state awaiting a signal from any other mobile unit as noted in Step S150. Upon receiving such a signal from an other mobile unit as noted in Step S160, the hands-free device is connected to the mobile unit as noted in Step S190. Step S195 merely indicates that process ends with the hands-free device being connected to a user's mobile telephone.

It is obvious that the technique in the prior art invention does not provide any user-chosen hands-free unit to be connected. Moreover, the hands-free unit is not capable of connecting to the mobile handset of the user when the connection is interrupted.

Therefore, there is need in providing a method for connecting a handset to a Bluetooth hands-free unit when the handset is to make or receive a phone call while being disconnected from the Bluetooth hands-free unit such that the driver can drive safely in a vehicle.

### SUMMARY OF THE INVENTION

It is a primary object of the present invention to provide a method for connecting a handset to a Bluetooth hands-free unit when the handset is to make or receive a phone call while being disconnected from the Bluetooth hands-free unit.

It is a secondary object of the present invention to provide a method for connecting a handset to a Bluetooth hands-free unit such that the driver can drive safely in a vehicle.

In order to achieve the foregoing objects, the present invention provides a method for connecting a handset to a Bluetooth hands-free unit, comprising steps of: determining a service port of the Bluetooth hands-free unit in a data base of the handset; establishing an initial connection between the handset and the Bluetooth hands-free unit according to the service port; performing an incoming call setup procedure in order for the Bluetooth hands-free unit to receive an incoming call; and performing a service level connection establishment procedure.

It is preferable that the data base comprises information of the Bluetooth hands-free unit. The information comprises at least one of: a Bluetooth address of the Bluetooth hands-free unit; a device class of the Bluetooth hands-free unit; a device class of the Bluetooth hands-free unit; last log-in time of the Bluetooth hands-free unit; and times of use of the Bluetooth hands-free unit.

It is preferable that the service port is obtained through a service discovery protocol (SDP).

It is preferable that the service level connection establishment procedure comprises a step of: exchanging AT commands.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a flowchart illustrating an example of the steps of the technique in the prior art;

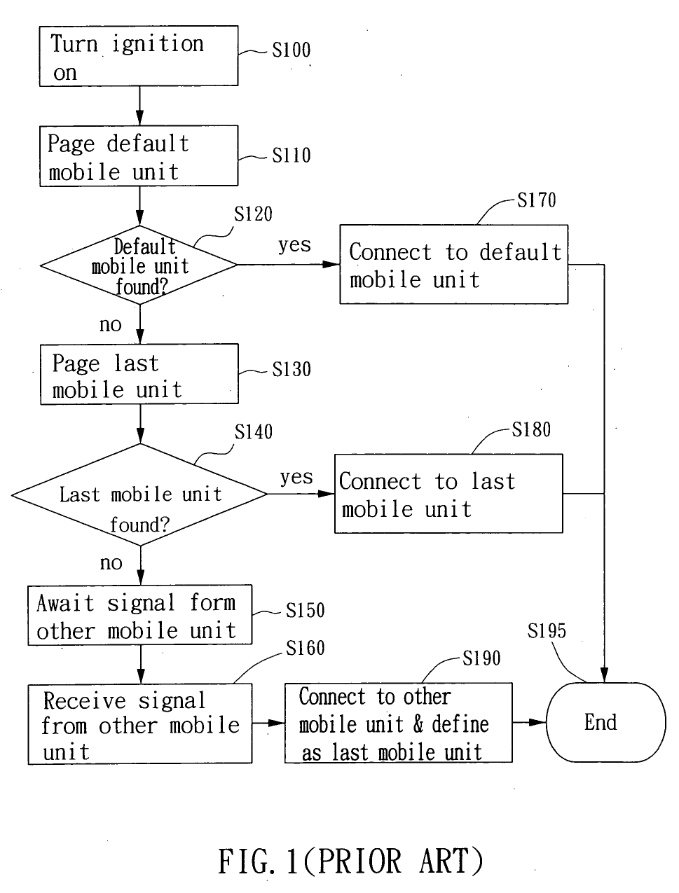

FIG. 2 is a flowchart illustrating briefly the steps for connecting a handset to a Bluetooth hands-free unit in accordance with the present invention;

FIG. 3 is a flowchart illustrating an example of the steps for connecting a handset to a Bluetooth hands-free unit in accordance with the present invention; and

FIG. 4 is a flowchart illustrating another example of the steps for making or receiving phone calls in accordance with the present invention.

### DETAILED DESCRIPTION OF THE PREFERRED EMBODIMENT

The present invention providing a method for connecting a handset to a Bluetooth hands-free unit can be exemplified by the preferred embodiment as described hereinafter.

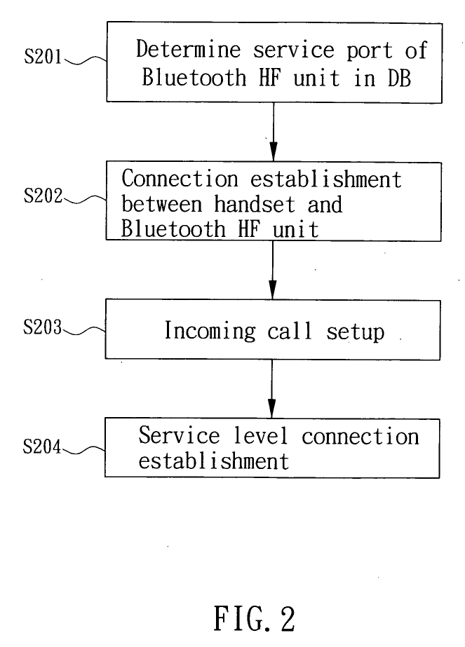

Please refer to FIG. 2, which is a flowchart illustrating briefly the steps for connecting a handset with Bluetooth module to a Bluetooth hands-free unit of car in accordance with the present invention. Initially in Step S201, a service port of the Bluetooth hands-free unit is determined according to a data base of a handset. In the data base, there is preferably stored information of the Bluetooth hands-free unit, which comprises at least one of: a Bluetooth address of the Bluetooth hands-free unit; a device class of the Bluetooth hands-free unit; a device class of the Bluetooth hands-free unit; last log-in time of the Bluetooth hands-free unit; and times of use of the Bluetooth hands-free unit.

Later in Step S202, the handset transmits a paging signal so as to establish an initial connection between the handset and the Bluetooth hands-free unit according to the service port. Otherwise, the handset tries to obtain a service port of the Bluetooth hands-free unit according to a service discovery protocol (SDP) so as to establish a connection between the handset and the Bluetooth hands-free unit. Once the initial connection is failed and the service port cannot be obtained through the SDP, it is required that another service port of a Bluetooth hands-free unit is selected from the data base.

After the initial connection is established, an incoming call setup procedure is performed in order for the Bluetooth hands-free unit to receive an incoming call, as stated in Step S203. Generally, according to the Bluetooth specification, a service level connection is usually established before the initial connection. However, the service level connection establishment usually takes about 5 to 7 seconds. During such time interval, an incoming call may be hung up and thus the connection is thus interrupted. In the present invention, when the incoming call setup procedure completed, the user can pick up the incoming call by using the Bluetooth hands-free unit instead of the handset. Since the incoming call setup procedure is in the Bluetooth Standards, it is compatible with the handset and the Bluetooth hands-free unit.

In Step S204, a service level connection establishment procedure is performed. The service level connection establishment procedure is for providing supports and status between of the handset and the Bluetooth hands-free unit. The procedure comprising a step of exchanging AT commands.

After the connection between the handset and the Bluetooth hands-free unit is interrupted, handset stays idle and awaits a connection request from the Bluetooth hands-free unit. The handset does not automatically connect to the Bluetooth hands-free unit until an incoming call appears.

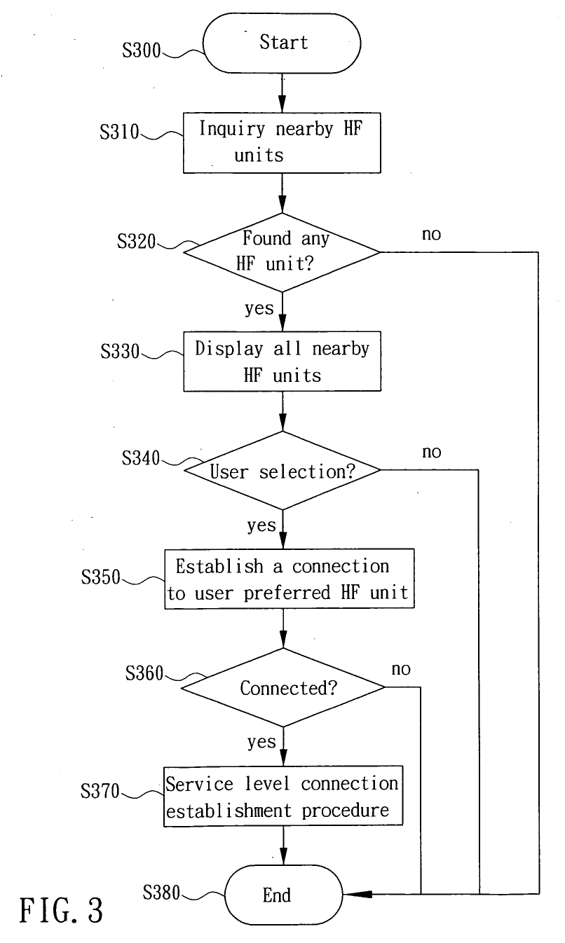

Please refer to FIG. 3, which is a flowchart illustrating an example of the steps for connecting a handset to a Bluetooth hands-free unit in accordance with the present invention. When the Bluetooth System of the handset is activated (Step S300), the handset inquiries the nearby Bluetooth hands-free units within a certain range (Step S310). Once any Bluetooth hands-free unit is found (Step S320), the handset displays a list of all available Bluetooth hands-free units (Step S330) in order for the user to select his or her preferred one. After the user to selects his or her preferred one (Step S340), a connection between the handset and the user-selected is established (Step S350). Once the connection is made (Step S360), a service level connection establishment procedure is performed (Step S370). Step S380 merely indicates that process ends with the hands-free unit being connected to the handset. In the foregoing example, if no Bluetooth hands-free unit is found or the user gives up selecting a hands-free unit to be connected, the process ends as well.

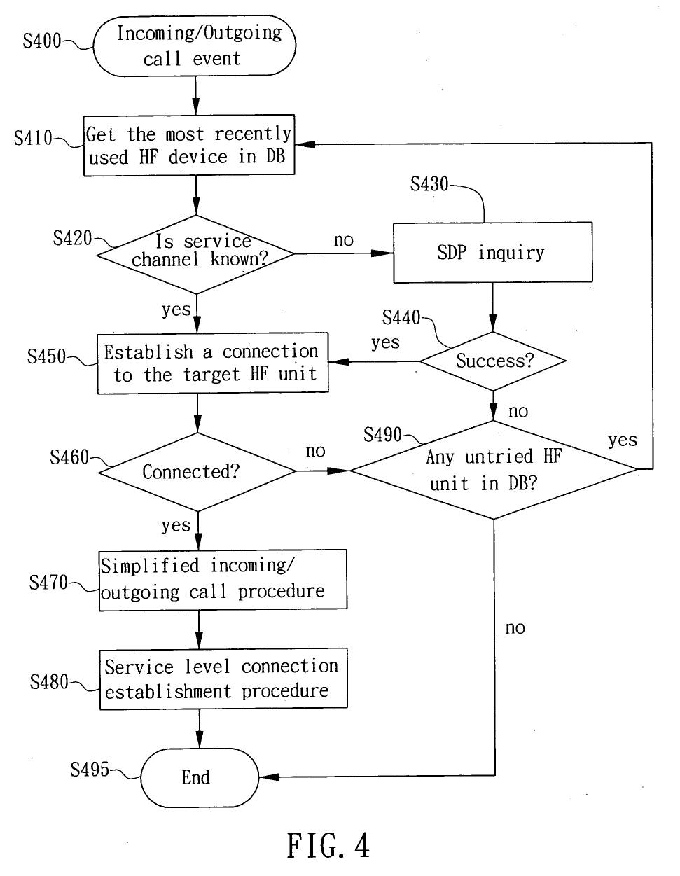

Please further refer to FIG. 4, which is a flowchart illustrating an example of the steps for making or receiving phone calls in accordance with the present invention. When a handset and a Bluetooth hands-free unit are not connected and an incoming/outgoing call event occurs (Step S400), a most frequently used Bluetooth hands-free unit is selected by a service port from a data base in the Bluetooth hands-free unit (Step S410). The service port is then determined whether it is already known or not (Step S420). If the service port is already known, an initial connection is made from the handset to the Bluetooth hands-free unit (Step S450). Otherwise, a service discovery protocol (SDP) is preformed so as to inquiry the service port (Step S430). Once the service channel is found (Step S440), an initial connection is made from the handset to the Bluetooth hands-free unit (Step S450). Otherwise, when the connection is made (Step S460), the incoming/outgoing call procedure is simplified (Step S470). In other words, an initial connection is made. Then, a service level connection establishment procedure is performed (Step S480). Step S495 merely indicates that process ends with the hands-free unit being connected to the handset. However, if a failure occurs during Step S430 or Step S450, it is determined whether there is any un-tried Bluetooth hands-free unit (Step S490). The process returns to Step S410 for selecting another Bluetooth hands-free unit from the data base when there is other un-tried Bluetooth hands-free unit; otherwise, the process ends.

According to the above discussion, it is apparent that the present invention discloses a method for connecting a handset to a Bluetooth hands-free unit when the handset is to make or receive a phone call while being disconnected from the Bluetooth hands-free unit such that the driver can drive safely in a vehicle. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for connecting a handset to a Bluetooth hands-free unit, comprising steps of:
determining a service port of said Bluetooth hands-free unit in a data base of said handset;
establishing an initial connection between said handset and said Bluetooth hands-free unit according to said service port;
performing an incoming call setup procedure in order for said Bluetooth hands-free unit to receive an incoming call; and
performing a service level connection establishment procedure.

2. The method as recited in claim 1, wherein said data base comprises information of said Bluetooth hands-free unit.

3. The method as recited in claim 2, wherein said information comprises a Bluetooth address of said Bluetooth hands-free unit.

4. The method as recited in claim 2, wherein said information comprises a device class of said Bluetooth hands-free unit.

5. The method as recited in claim 2, wherein said information comprises last log-in time of said Bluetooth hands-free unit.

6. The method as recited in claim 2, wherein said information comprises times of use of said Bluetooth hands-free unit.

7. The method as recited in claim 1, wherein said service port is obtained through a service discovery protocol (SDP).

8. The method as recited in claim 1, wherein said service level connection establishment procedure comprises a step of:
exchanging AT commands.

9. The method as recited in claim 1, wherein said handset stays idle after said handset is disconnected from said Bluetooth hands-free unit.

10. The method as recited in claim 9, wherein said handset awaits a connection request from said Bluetooth hands-free unit when said handset is staying idle.

11. The method as recited in claim 9, further comprising steps after said handset receives connection request, said steps comprising:
determining a service port of said Bluetooth hands-free unit in a data base of said handset;
establishing an initial connection between said handset and said Bluetooth hands-free unit according to said service port;
performing an incoming call setup procedure in order for said Bluetooth hands-free unit to receive an incoming call; and
performing a service level connection establishment procedure.

12. The method as recited in claim 1, wherein when the an incoming call setup procedure completed, a user picks up the incoming call by using the Bluetooth hands-free unit.
